(19) United States
(12) Patent Application Publication
(10) Pub. No.: US 2006/0025967 A1
(43) Pub. Date: Feb. 2, 2006

(54) Replaceable component life tracking for idled components in an electrophotographic print engine

(75) Inventors: Joseph J. Furno, Pittsford, NY (US); Richard R. T. Carling, Webster, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/903,044

(22) Filed: Jul. 30, 2004

(51) Int. Cl. G21C 17/00

(52) U.S. Cl. 702/184

(57) ABSTRACT

A replaceable component life tracking method and system for multi-operating mode systems having replaceable components with variable wear rates that depend on the system operating mode. The method tracks system use and replaceable component life using a common predetermined parameter, and uses a different predetermined replaceable component wear rate, when necessary, for each replaceable component for each operating mode. The predetermined wear rate for each replaceable component in each operating mode is factored into the accumulated use of each replaceable component in each operating mode before computing the overall accumulated life of each replaceable component.

### FIELD OF THE INVENTION

This invention relates to the maintenance of systems with replaceable components, and more particularly, to maintenance of systems with replaceable components that have more than one operating mode with different wear rates in different operating modes.

### BACKGROUND OF THE INVENTION

Many systems have multiple components that wear at different rates and are replaced as they wear out in order to keep the whole system operating. In such systems the replacement of some or all worn out components may require specially trained service professionals such as field service engineers. Some systems may be designed with replaceable components that are replaceable by the system operator, thereby eliminating or, at least reducing the frequency of, the need to place a service call. This not only may reduce overall maintenance costs, but also reduces system down time by eliminating response time. In either case, replacement by a service call or by the operator, it is desirable to track the usage of replaceable components so as to accurately anticipate when they will fail. U.S. Pat. No. 6,718,285 issued to Schwartz, et al., henceforth referred to as the Schwartz patent, discloses a replaceable component life tracking system and is hereby incorporated in this application by reference.

The Schwartz patent discloses a replaceable component life tracking system in which all replaceable components are fully operational during system operation, the system operation being tracked by a predetermined parameter. Each replaceable component may have a different expected life span in terms of the predetermined parameter, but they each wear at the same rate toward the end of their expected life span during system operation. The Schwartz replaceable component life tracking system is applicable to many systems. However systems exist which have more than one system operating mode, and in addition have replaceable components that have different operating modes, with different wear rates in the different operating modes. For example, in such a system, a given replaceable component may be fully operating in one system operating mode, but may run in an idle mode in a different system operating mode. In the idle mode the given replaceable component may only be partially operating, and therefore still wearing, but at a lower rate than in the fully operating mode. Further, there may be system operating modes in which a given replaceable component may not be running at all and therefore not wearing. Tracking the life of replaceable components in such multi-mode systems is a more daunting problem than for those single mode systems with single mode replaceable components.

### SUMMARY OF THE INVENTION

The present invention provides a replaceable component life tracking method and system for multi-operating mode systems having replaceable components with variable wear rates that depend upon the system operating mode. The method of the present invention tracks system use and replaceable component life using a common predetermined parameter, but uses a different predetermined replaceable component wear rate, when necessary, for each replaceable component for each operating mode. The predetermined wear rate for each replaceable component in each operating mode is factored into the accumulated use of each replaceable component in each operating mode before computing the overall accumulated life of each replaceable component.

The invention, and its objects and advantages, will become more apparent in the detailed description of the preferred embodiment presented below.

### BRIEF DESCRIPTION OF THE DRAWINGS

FIG. 1 is an illustration of a system having a digital printer and a user interface that is a preferred embodiment of the invention;

FIG. 2 is an illustration of the digital printer of FIG. 1 with the cabinetry removed showing a number of operator replaceable components;

FIG. 3 is a basic high-level flowchart of a method of replaceable component life tracking in a printing system having just a single four color operating mode;

FIG. 4 is a basic high-level flowchart for life tracking of idled replaceable components in the method of the present invention; and

FIG. 5 is a block diagram of the software components in the Main Machine Controller that controls the digital printer of FIG. 1 in an embodiment of the present invention.

### DETAILED DESCRIPTION OF THE INVENTION

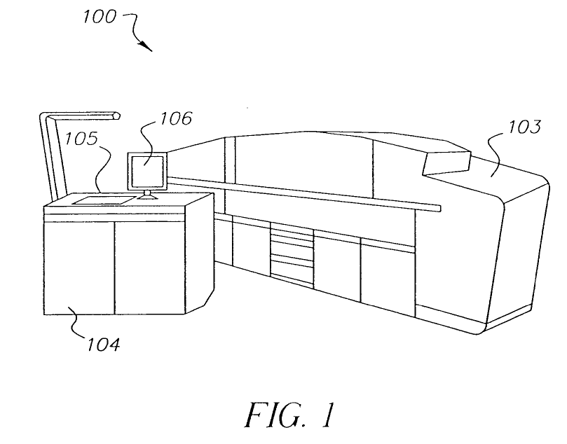

FIG. 1 is an illustration of a system 100 according to the preferred embodiment of the present invention, and includes a digital printer 103 and a Digital Front End (DFE) controller 104. Digital printer 103 is provided with Operator Replaceable Component (ORC) devices that enable a typical operator to perform the majority of maintenance on the system without requiring the services of a field engineer. The ORC devices in the preferred embodiment are those components within systems that become worn after periods of use. Specifically, the ORC devices are those components used within digital printing systems that wear with use. These ORC devices within the preferred embodiment have predictable lifetimes that can be anticipated by parameters relative to the use of the digital printer 103. Therefore, it is possible to anticipate when these ORC devices will need to be replaced before the wear on them results in less than desirable performance in the system 100. Digital printer 103, in the preferred embodiment, is a NexPress® 2100 digital color on demand printing press, however, the present invention pertains to systems in general and digital printing systems in particular.

DFE controller 104 located adjacent to the printer 103, and includes a computational element 105 that interfaces with a database management system within the DFE controller 104, and a Graphical User Interface (GUI) 106 that communicates with computational element 105. In the preferred embodiment, GUI 106 on the DFE controller 104 provides the operator with the ability to view the current status of ORC devices in the digital printer 103, and to thus perform maintenance in response to maintenance information provided on the graphical display on GUI 106, as well as to view various alerts that are provided from the DFE controller 104. It should be understood that while the preferred embodiment details a system 100 with a digital printer 103 having at least one computational element and another computational element associated with DFE controller 106, similar systems can be provided with more computational elements or fewer computational elements, and that these variations will be obvious to those skilled in the art. In general, virtually any interactive device can function as DFE controller 104, and specifically any Graphics User Interface (GUI) 106 can function in association with DFE controller 104 as employed by the present invention.

The database management system within the DFE controller 104 will receive data that details the usage of each of the ORC devices based on the number of prints made, the types of paper being used, the color composition of the printed pages as well as various sensor inputs. The database management system then takes the received data and creates a life tracking system that keeps track of the remaining life of the ORC devices and informs the operator of remaining life via the GUI 106. The preferred embodiment employs tables displayed on the GUI 106 to inform the operators to the current status of the ORC devices. However, it should be noted that numerous variations are possible including, but not limited to, direct messages related to a single ORC device, various types of alarms, or even graphical messages on the GUI 106. The database management system will also prompt the operator when any of the ORC devices need to be replaced. The digital printing system 100 of the present invention provides tracking of the ORC devices in an ORC tracking table along with an automated transmission of the ORC Tracking Table to the GUI 106. The preferred embodiment of the present invention uses page count and parameters related to customer usage to create the ORC tracking chart. When an operator replaces an ORC, the life counter for that ORC is reset.

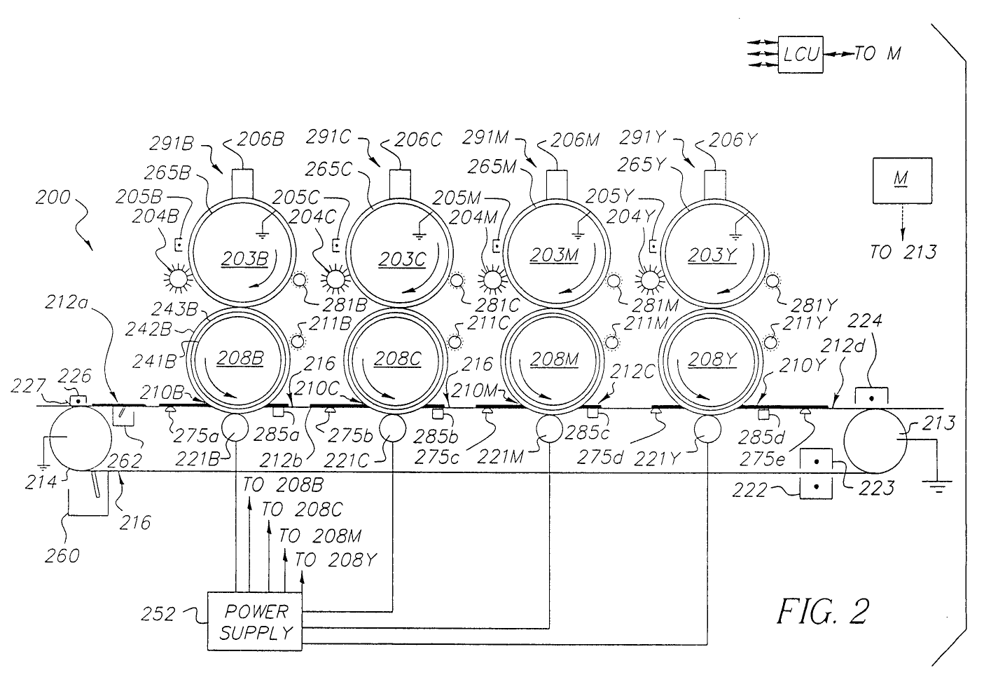

Referring now to FIG. 2 of the accompanying drawings, a portion of the inside of digital printer 103 is illustrated, showing the image forming reproduction apparatus according to the preferred embodiment of the present invention, designated generally by the numeral 200. The reproduction apparatus 200 is in the form of an electrophotographic reproduction apparatus and more particularly a color reproduction apparatus wherein color separation images are formed respectively in each of four color modules, and transferred in register to a receiver member as a receiver member is moved through the apparatus while supported on a paper transport web (PTW) 216. The apparatus 200 illustrates the image forming areas for a digital printer 103 having four color modules, although the present invention is applicable to printers of all types, including printers that print with more or less than four colors.

The elements in FIG. 2 that are similar from module to module have similar reference numerals with a suffix of B, C, M and Y referring to the color module with which the element is associated; i.e., black, cyan, magenta and yellow, respectively. Each module (291B, 291C, 291M, 291Y) is of similar construction. PTW 216, which may be in the form of an endless belt, operates in association with all the modules 291B, 291C, 291M, 291Y, and a receiver member is transported by PTW 216 from module to module. Four receiver members, or sheets, 212a, b, c and d are shown simultaneously receiving images from the different modules, it being understood that each receiver member may receive one color image from each module and that in this example up to four color images can be received by each receiver member. The movement of the receiver member with the PTW 216 is such that each color image transferred to the receiver member at the transfer nip of each module is a transfer that is registered with the previous color transfer so that a four-color image formed on the receiver member has the colors in registered superposed relationship on the receiver member. The receiver members are then serially detacked from the PTW 216 and sent to a fusing station (not shown) to fuse or fix the toner images to the receiver member. The PTW 216 is reconditioned for reuse by providing charge to both surfaces using, for example, opposed corona chargers 222, 223 which neutralize the charge on the two surfaces of the PTW 216. These chargers 222, 223 are operator replaceable components within the preferred embodiment and have an expected life span after which chargers 222, 223 will require replacement.

Each color module includes a primary image-forming member (PIFM), for example a rotating drum 203B, C, M and Y, respectively. The drums rotate in the directions shown by the arrows and about their respective axes. Each PIFM rotating drum 203B, C, M and Y has a photoconductive surface, upon which a pigmented marking particle image is formed. The PIFM rotating drums 203B, C, M and Y have predictable lifetimes and constitute operator replaceable components. The photoconductive surface for each PIFM 203B, C, M and Y within the preferred embodiment is actually formed on outer sleeves 265B, C, M and Y, upon which the pigmented marking particle image is formed. These outer sleeves 265B, C, M and Y, have lifetimes that are predictable and therefore, are operator replaceable components. In order to form images, the outer surface of the PIFM is uniformly charged by a primary charger such as a corona charging devices 205B, C, M and Y, respectively or other suitable charger such as roller chargers, brush chargers, etc. The corona charging devices 205B, C, M and Y each have a predictable lifetime and are operator replaceable components. The uniformly charged surface is exposed by suitable exposure mechanism 206B, C. M and Y, such as, for example, a laser, or more preferably an LED or other electro-optical exposure device, or even an optical exposure device, to selectively alter the charge on the surface of the outer sleeves 265B, C, M and Y, of the PIFM rotating drums 203B, C, M and Y to create an electrostatic latent image corresponding to an image to be reproduced. The electrostatic image is developed by application of pigmented charged marking particles to the latent image bearing photoconductive drum by a development station 281B, C, M and Y, respectively. Each of the development stations 281B, C, M and Y has a particular color of pigmented marking particles associated respectively therewith. Thus, each module creates a series of different color marking particle images on the respective photoconductive drum. The development stations 281B, C, M and Y, have predictable lifetimes before they require replacement and are operator replaceable components. In lieu of a photoconductive drum, which is preferred, a photoconductive belt can be used.

Each marking particle image formed on a respective PIFM rotating drum is transferred electrostatically to an intermediate transfer module (ITM) 208B, C, M and Y, respectively. The ITM 208B, C, M and Y have an expected lifetime and are, therefore, considered to be operator replaceable components. In the preferred embodiment, each ITM 208B, C, M and Y, has an outer sleeve 243B, C, M and Y that contains the surface to which the image is transferred from PIFM rotating drums 203B, C, M and Y. These outer sleeves 243B, C, M and Y are considered operator replaceable components with predictable lifetimes. The PIFM rotating drums 203B, C, M and Y are each caused to rotate about their respective axes by frictional engagement with their respective ITM 208B, C, M and Y. The arrows in the ITMs 208B, C, M and Y indicate the direction of their rotation. After transfer, the toner image is cleaned from the surface of the photoconductive drum by a suitable cleaning device 204B, C, M and Y, respectively to prepare the surface for reuse for forming subsequent toner images. Cleaning devices 204B, C, M and Y are considered operator replaceable components by the present invention.

Marking particle images are respectively formed on the surfaces 242B, C, M and Y for each of the outer sleeve 243B, C, M and Y for ITMs 208B, C, M and Y. The marking particle images are transferred to a receiving surface of a receiver member, which is fed into a nip between the intermediate image transfer member drum and a transfer backing roller (TBR) 221B, C, M and Y, respectively. The TBRs 221B, C, M and Y have predictable lifetimes and are considered to be operator replaceable components by the invention. Each TBR 221B, C, M and Y, is suitably electrically biased by a constant current power supply 252 to induce the charged toner particle image to electrostatically transfer to a receiver sheet. Although a resistive blanket is preferred for TBR 221B, C, M and Y, the TBR 221B, C, M and Y can also be formed from a conductive roller made of aluminum or other metal. The receiver member is fed from a suitable receiver member supply (not shown) and is suitably “tacked” to the PTW 216. The receiver member moves serially into each of the nips 210B, C, M and Y where it receives the respective marking particle image in a suitable registered relationship to form a composite multicolor image. As is well known, the colored pigments can overlie one another to form areas of colors different from that of the pigments.

The receiver member exits the last nip and is transported by a suitable transport mechanism (not shown) to a fuser where the marking particle image is fixed to the receiver member by application of heat and/or pressure. A detack charger 224 may be provided to deposit a neutralizing charge on the receiver member to facilitate separation of the receiver member from the PTW 216. The detack charger 224 is another component that is considered to be an operator replaceable component within the scope of this invention. The receiver member with the fixed marking particle image is then transported to a remote location for operator retrieval. The respective ITMs 208B, C, M and Y are each cleaned by a respective cleaning device 211B, C, M and Y to prepare it for reuse. Cleaning devices 211B, C, M and Y are considered by the invention to be operator replaceable components having lifetimes that can be predicted.

Appropriate sensors (not shown) of any well known type, such as mechanical, electrical, or optical sensors for example, are utilized in the reproduction apparatus 200 to provide control signals for the apparatus. Such sensors are located along the receiver member travel path between the receiver member supply through the various nips to the fuser. Further sensors may be associated with the primary image forming member photoconductive drum, the intermediate image transfer member drum, the transfer backing member, and various image processing stations. As such, the sensors detect the location of a receiver member in its travel path, and the position of the primary image forming member photoconductive drum in relation to the image forming processing stations, and respectively produce appropriate signals indicative thereof. Such signals are fed as input information to a microprocessor based logic and control unit LCU which has an associated computational element. Based on such signals and a suitable program for the microprocessor, the control unit LCU produces signals to control the timing operation of the various electrostatographic process stations for carrying out the reproduction process and to control, for example, drive by motor M for various drums and belts. The production of a program for a number of commercially available microprocessors, which are suitable for use with the invention, is a conventional skill well understood in the art. The particular details of any such program would, of course, depend on the architecture of the designated microprocessor.

The receiver members utilized with the reproduction apparatus 200 can vary substantially. For example, they can be thin or thick paper stock (coated or uncoated) or transparency stock. As the thickness and/or resistivity of the receiver member stock varies, the resulting change in impedance affects the electric field used in the nips 210B, C, M, Y to urge transfer of the marking particles to the receiver members. Moreover, a variation in relative humidity will vary the conductivity of a paper receiver member, which also affects the impedance and hence changes the transfer field. Such humidity variations can affect the expected lifetime of operator replaceable components.

In feeding a receiver member onto PTW 216, charge may be provided on the receiver member by charger 226 to electrostatically attract the receiver member and “tack” it to the PTW 216. A blade 227 associated with the charger 226 may be provided to press the receiver member onto the belt and remove any air entrained between the receiver member and the PTW. The PTW 216, the charger 226 and the blade 227 are considered operator replaceable components.

The endless transport web (PTW) 216 is entrained about a plurality of support members. For example, as shown in FIG. 2, the plurality of support members are rollers 213, 214 with preferably roller 213 being driven as shown by motor M to drive the PTW. Support structures 275a, b, c, d and e are provided before entrance and after exit locations of each transfer nip to engage the PTW 216 on the backside and alter the straight line path of the PTW to provide for wrap about each respective ITM. This wrap allows for a reduced pre-nip ionization and for a post-nip ionization which is controlled by the post-nip wrap. The nip is where the pressure roller contacts the backside of the PTW or, where no pressure roller is used, where the electrical field is substantially applied. However, the image transfer region of the nip is a smaller region than the total wrap. Pressure applied by the transfer backing rollers (TBRs) 221B, C, M and Y is upon the backside of the belt 216 and forces the surface of the compliant ITM to conform to the contour of the receiver member during transfer. The TBRs 221B, C, M and Y may be replaced by corona chargers, biased blades or biased brushes, each of which would be considered by this invention to be operator replaceable components. Substantial pressure is provided in the transfer nip to realize the benefits of the compliant intermediate transfer member which are a conformation of the toned image to the receiver member and image content on both a microscopic and macroscopic scale. The pressure may be supplied solely by the transfer biasing mechanism or additional pressure applied by another member such as a roller, shoe, blade or brush, all of which are operator replaceable components according to the present invention.

Four color printing, such as in the embodiment illustrated in FIG. 2, is most common. Typically such four color printing devices operate in a single mode, which prints black, cyan, magenta, and yellow images in register on receiver sheets to form combinations of text and pictorial images. During printing in this single mode, all replaceable components for all color modules are fully operating. The Schwartz patent, disclosed above, discloses a replaceable component life tracking system in such a printing system in which all replaceable components are fully operational during system operation, the system operation being tracked by the number of four color pages printed. Each replaceable component may have a different expected life span in terms of the number of four color pages printed, but they each wear at the same rate toward the end of their expected life span during system operation.

Printing systems, such as in the embodiment illustrated in FIG. 2, can be designed to operate in modes other than four color printing as described above. For example, such a system could have a black-only printing mode or a spot color printing mode that uses only one or two of the color modules. In such system operating modes one or more of the color modules, 291B, C, M, and Y in FIG. 2 will by running in an idle mode and the replaceable components associated with those idling modules may be wearing at a lower rate than in the fully operational mode or perhaps not wearing at all. In addition to the possible alternate operating modes described above for the printing system illustrated in FIG. 2, such a printing system could be designed with additional imaging modules for printing specialty colors in addition to black, cyan, magenta, and yellow. Examples of uses for additional printing modules are: 1) printing pictorial images with color marking particles in addition to cyan, magenta, and yellow to increase the color gamut attainable with just those three subtractive primary color marking particles; 2) printing with marking particles specially formulated to match a desired spot color such as a company logo; 3) printing with clear colorless marking particles to provide a protective or gloss enhancing overcoat for the colored image, or to reduce the relief appearance of some marking particle images. Such printing systems with more than four printing modules would obviously have multiple printing modes, including four color printing. In some of those printing modes one or more modules would be running in an idle mode and the replaceable components associated with those idling modules may be wearing at a lower rate than in the fully operational mode or perhaps not wearing at all.

One embodiment of the present invention is used in a printing system as illustrated in FIG. 2 but with a fifth printing module in addition to 291B, C, M, and Y, such fifth printing module capable of being used for any of the above described uses. Such fifth module, not shown, would include the same components as modules 291B, C, M, and Y, that is, an image forming member 203 with photoconductor coated outer sleeve 265, a primary charging device 205, exposure mechanism 206, a development station 281, an intermediate transfer member 208 with outer sleeve 243, cleaning devices 204 and 211, and a transfer backing roller 221. Several development stations 281 might be available for use in a fifth printing module to accommodate the use of different color marking particles in different printing runs without having to change the marking particle developer in the developer station for each printing run.

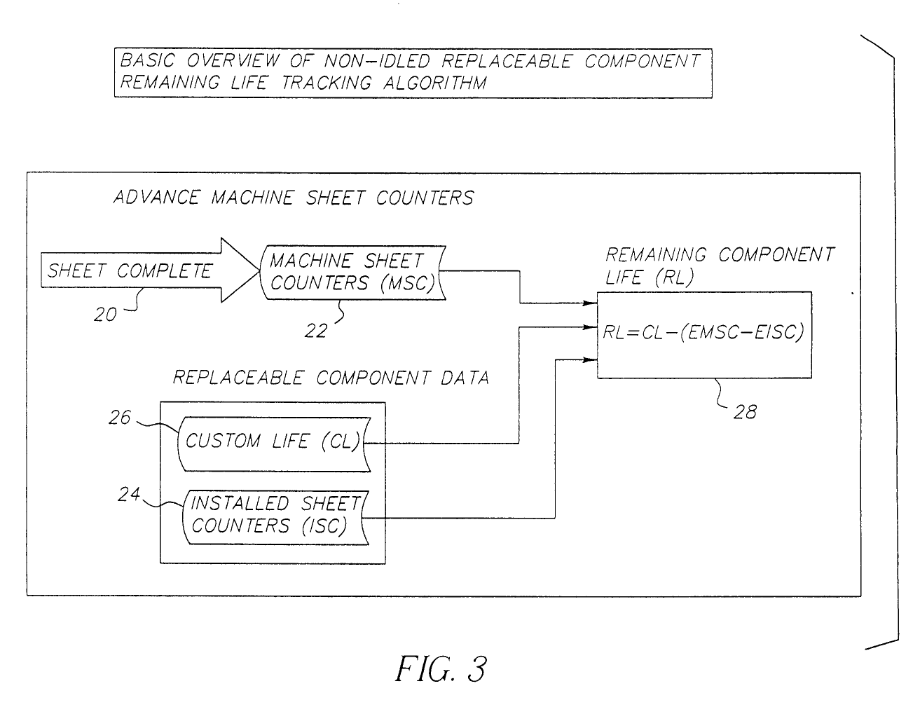

The replaceable component life tracking method for the printing system illustrated in FIG. 2 with no fifth module and only one four color printing mode treats all replaceable components as though they are all running and depleting their useful life as documents are printed. FIG. 3 is a basic high-level flowchart of this method. As sheets are printed and delivered to the output destination, they are identified as a “sheet complete” 20 which results in a corresponding Machine Sheet Counter (MSC) 22 being advanced. These MSCs 22, which are advanced when sheets are printed, are used as the base from which the amount of wear of the replaceable component is tracked and thus are used to determined the remaining life of the operator replaceable components. Each operator replaceable component has a set of Installed Sheet Counters (ISC) 24 associated therewith. When an operator replaceable component is installed, the ISCs 24 are loaded with the MSC 22 values at the time of replacement. This establishes a reference from where the remaining life of the respective operator replaceable components is derived as prints are being generated and the MSCs 22 are advancing. Each operator replaceable component also has a life expectancy or Custom Life (CL) 26 value associated therewith for the calculation of the operator replaceable component's remaining life. This CL 26 value is specific to each operator replaceable component and is derived from the life history of replacements for that specific operator replaceable component. The final remaining life calculation 28 is determined by first normalizing the MSC and ISC to a single equivalent base sheet size count, EMSC and EISC, and then subtracting this from the custom life of the replaceable component.

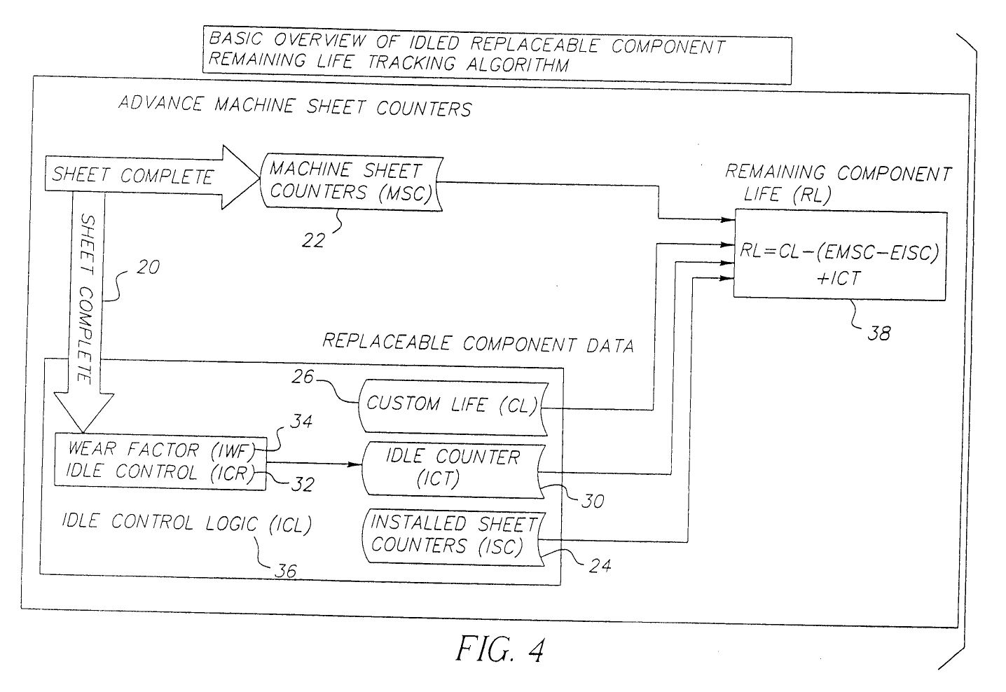

The operator replaceable component life tracking method of the present invention takes into account the idle mode running of some of the replaceable components in a printing system such as illustrated in FIG. 2, when such a system is operated in modes other than four color as described above. FIG. 4 is a basic high-level flowchart for life tracking of idled replaceable components according to the method of the present invention. The method of the present invention utilizes three new tracking components for each operator replaceable component: 1) an idle control (ICR) 32 parameter used to configure the replaceable component as an idle-able component; 2) an idle counter (ICT) 30 parameter used to keep track of the number of equivalent base sheet size counts while the replaceable component is idled; and 3) an idle wear factor (IWF) 34 parameter used to calculate a new ICT 30 value as sheets are being printed. As sheets are being printed, the sheet complete information 20 is sent to the replaceable component tracking system where the information is used by an Idle Control Logic (ICL) 36 functionality. The ICL 36 will determine which replaceable components are idled and appropriately advance each idled components ICT 30 based on the sheet complete information and the components IWF 34.

As indicated above, some components, such as a development station, my be idled by removing it from the machine, which may result in a “zero wear” factor. However, some replaceable components, my be idle but are left in the machine. For example, a fifth module image forming member 203 my not be in use, thus it is being idled, however it still may be rotating or is exposed to various gases and chemical vapors, and thus has a non-zero wear factor resulting in some wear while being idled. A remaining life calculation 38 according to the method of the present invention is now determined by first normalizing the machine sheet counters (MSC) 22 and installed sheet counters (ISC) 24 to a single equivalent base sheet size counts, EMSC and EISC, as in the single four color mode method, then subtracting this from the custom life (CL)₂₆ of the replaceable component, and lastly adding in the ICT 30 value for the replaceable component. This now takes into account the idle time use of the replaceable component and prevents premature replacements.

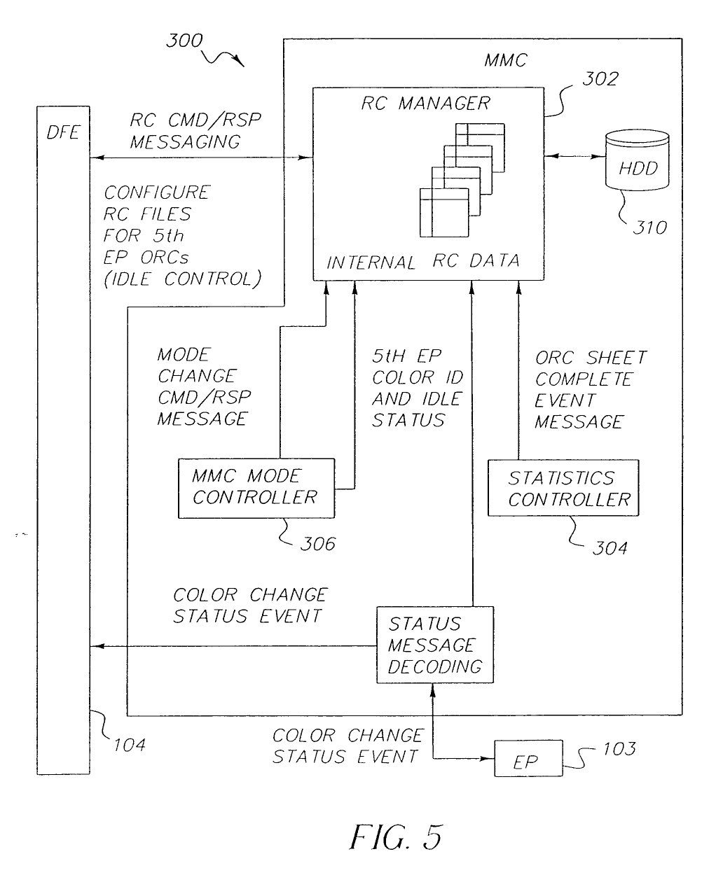

FIG. 5 is a block diagram of the software components in the Main Machine Controller (MMC) 300 that controls the digital printer 103 of FIG. 1 in which the above embodiment of the present invention is used. MMC 300 controls the printing process of digital printer 103 which is illustrated in FIG. 2, and communicates with the Digital Front End (DFE) 104 of FIG. 1.

The RC Manager 302 is responsible for maintaining replaceable component (RC) data, tracking remaining life of the RCs, and sending exception events to the DFE 104 and operator to indicate when RCs need replacement/attention. RC data includes, but is not limited to: enabled status, expiration status, expiration type, last replacement date, last replacement sheet counter data, idle count, idle control, and replacement history data for prior replacements. The RC Manager 302 stores this data to the MMC Hard Disk Drive (HDD) 310 when replacements, configuration changes, or updates are made.

The Statistics Controller 304 is responsible for maintaining the various sheet counters/meters for sheets that have been printed for the life of the machine. When sheets are printed/delivered to the output source, the Statistics Controller 304 is notified via a Sheet Complete Event Message and this triggers the Statistics Controller 304 to update the sheets counters accordingly. The Statistics Controller 304 also in turn sends this data to the RC Manager 302 for the purpose of updating the RC idle counters for those RC that are being idled. The Statistics Controller 304 also stores the sheet counters in NVRAM where they are made available to the RC Manager 302 as well as preserving the data.

The MMC Mode Controller 306 is responsible for the proper cycling-up of the digital printer 103 in the desired 4-color or 5-color mode. The MMC Mode Controller 306 sends this information to the RC Manager 302 which indicates if a printing module (291B, C, M, Y, or a fifth module in FIG. 2) has been fully cycled-up or is cycled-up into an idle mode. The Mode Controller 306 determines how to cycle-up the 5th module (can be extended to other modules as well) based on the DFE press policy and by development station status information send to the MMC from the printing modules.

The foregoing discussion has described the preferred embodiment of the present invention, but variations will be readily apparent to those of ordinary skill in the art, and therefore the scope of the invention should be measured by the appended claims.

What is claimed is:

1. In a system with a plurality of replaceable components, each said replaceable component (RC) capable of being used in a full operation mode or in an idle mode, a method of tracking the life of each said RC, said method comprising the steps of:
tracking a system use using a predetermined parameter;
for each said RC, providing a predetermined life expectancy in terms of said predetermined parameter;
for each said RC, providing a predetermined wear factor corresponding to wear during said idle mode;
for each said RC, tracking a full operation mode use and an idle mode use, using said predetermined parameter;
for each said RC, calculating an accumulated life using said predetermined parameter, said accumulated life being determined according to the formula:
accumulated life=(full operation mode use)+(idle mode use)(wear factor);
for each said RC, comparing said accumulated life with said predetermined life expectancy; and
reporting to the system operator the result of the comparing step, for all said replaceable components, on a periodic basis, said periodic basis being a predetermined amount of said system use.

2. The method of claim 1, further comprising the step of notifying the system operator as soon as said accumulated life becomes equal to or greater than said life expectancy for any one of said replaceable components.

3. The method of claim 2, wherein the step of notifying further includes determining if the RC for which said accumulated life became equal to or greater than said life expectancy was replaced and, if said RC was replaced, re-setting said accumulated life of said RC to zero.

4. The method of claim 3, wherein said system is a printing device and wherein said predetermined parameter is the number of pages printed.

5. The method of claim 4, wherein said predetermined parameter further includes a categorization of pages printed.

6. The method of claim 5, wherein said predetermined parameter further includes the size of pages printed.

7. The method of claim 5, wherein said predetermined parameter further includes a color related parameter.

8. In a machine, capable of a plurality of machine operating modes, with a plurality of replaceable components, each said replaceable component (RC) having a predetermined life, each said RC capable of being used in a full operation mode or in an idle mode, dependent upon said machine operating mode, and each said RC having a wear rate in said idle mode less, by a wear factor fraction, than in said full operation mode, a machine control system for tracking the life of each replaceable component, said machine control system comprising:
a Machine Mode Controller (MMC) which determines said machine operating mode in response to a machine operator input via a user interface;
a Statistics Controller (SC) which tracks said machine use in each of said machine operating modes using a predetermined parameter; and
an RC Manager, said RC manager connected to said MMC and to said SC and having stored in memory said wear factor fraction for each said RC, which tracks, in response to signals from said MMC and said SC, using said predetermined parameter, a full mode use and an idle mode use for each said RC, calculates for each said RC an accumulated life according to the formula:
(accumulated life)=(full operation mode use)+(idle mode use)(wear factor fraction),
compares said accumulated life to said life expectancy for each said RC, and reports to said machine operator via said user interface, on a periodic basis, said accumulated life for each said RC.

9. The machine control system of claim 8, wherein said operator interface is a graphical user interface.

10. The machine control system of claim 9, wherein said periodic basis is a predetermined amount of said machine use.

11. The machine control system of claim 10, wherein said RC Manager further notifies said system operator as soon as said accumulated life becomes equal to or greater than said life expectancy for any one of said replaceable components.

12. The machine control system of claim 11, wherein said RC Manager further determines if the RC for which said accumulated life became equal to or greater than said life expectancy was replaced and, if said RC was replaced, re-sets said accumulated life of said RC to zero.

13. The machine control system of claim 12, wherein said machine is a printing device and wherein said predetermined parameter is the number of pages printed.

14. The machine control system of claim 13, wherein said predetermined parameter further includes a categorization of pages printed.

15. The machine control system of claim 14, wherein said predetermined parameter further includes the size of pages printed.

16. The machine control system of claim 14, wherein said predetermined parameter further includes a color related parameter.
